(19) United States
(12) Patent Application Publication
(10) Pub. No.: US 2016/0055505 A1
(43) Pub. Date: Feb. 25, 2016

(54) PRICE ELASTICITY TESTING

(71) Applicant: Duetto Research, Inc., San Francisco, CA (US)

(72) Inventors: Neelav Rana, San Francisco, CA (US); Marco Benvenuti, Las Vegas, CA (US); Michael Skinner, San Francisco, CA (US)

(21) Appl. No.: 14/466,830

(22) Filed: Aug. 22, 2014

(51) Int. Cl. G06Q 30/02; G06Q 10/02

(52) U.S. Cl. CPC G06Q 30/0206; G06Q 10/02

(57) ABSTRACT

An elasticity tester to initiate a price elasticity experiment during an experiment period, the price elasticity experiment to test a price elasticity for bookings made during the experiment period for a travel property for a day of arrival and adjusts a recommended price to an adjusted price for the travel property during the experiment period according to user-defined test configuration parameters. The elasticity tester further measures actual bookings made during the experiment period for the travel property for the day of arrival at the adjusted price and compares the actual bookings made at the adjusted price to forecasted bookings for the travel property at the recommended price.

### TECHNICAL FIELD

This disclosure relates to the field of data processing, and in particular to price elasticity testing.

### BACKGROUND

The travel and hospitality industry in the United States and throughout the world is an ever increasing business sector. Advances in Internet and computing technology have significantly increased the opportunities to capture data from both travelers and travel properties (e.g., hotels, motels, bed and breakfasts, condominiums, houses). For example, web site based systems are used to offer the sale and rental of many travel properties and are used to make a large percentage of travel bookings. During these bookings, a significant amount of user travel data is received. The travel data may include, for example, a destination city, specific properties, dates of arrival, length of stay, room type, property amenities, price quotes, availability information, and/or other travel information. Property owners and managers are looking for chances to use this travel data to improve decisions relating to the management and sale of units in their travel properties. The mere availability of this data, however, does not by itself improve decisions that may lead to increased profits for the travel property. Conventional revenue management systems and booking engines are not equipped to make sufficient use of the newly acquired user travel data to deliver actionable insights and analysis as needed.

### BRIEF DESCRIPTION OF THE DRAWINGS

The present invention will be understood more fully from the detailed description given below and from the accompanying drawings of various embodiments of the present invention, which, however, should not be taken to limit the present invention to the specific embodiments, but are for explanation and understanding only.

FIG. 1 is a block diagram illustrating a cloud computing environment for system triggered travel alerts, according to an embodiment.

FIG. 2 is a block diagram illustrating an elasticity tester, according to an embodiment.

FIG. 3 is a block diagram illustrating a demand forecasting and price determining processing flow, according to an embodiment.

FIG. 4 is a flow diagram illustrating an elasticity testing method, according to an embodiment.

FIG. 5 is a flow diagram illustrating an elasticity testing method, according to an embodiment.

FIG. 6 is diagram illustrating a booking curve for a price elasticity experiment, according to an embodiment.

FIG. 7 is a block diagram illustrating a computer system, according to an embodiment.

### DETAILED DESCRIPTION

The following description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the scope of the present invention.

Embodiments of a method and apparatus are described for price elasticity testing. In one embodiment, an elasticity tester manages experiments that test the elasticity of price or other factors with respect to the demand at a travel property. One goal is to determine whether minor adjustments to the offer price for a travel property on a given day will affect the number of bookings received (i.e., the demand). An experiment may run from a user configurable start day or time to an end day or time, where this period falls some time prior to the target day. A successful experiment may include one where the rate adjustment had very little effect on the number of bookings received (i.e., the actual bookings closely matched the forecasted bookings).

In one embodiment, the elasticity tester identifies a testing period for testing with respect to a future day. The elasticity tester increases the rate for a given segment (e.g., room type, rate code, booking portal) at the travel property during the testing period by a certain amount. The amount of the increase may be expressed as a whole amount or a percentage increase. The elasticity tester allows the test to run for the testing period and compares the bookings during the testing period with the adjusted rate to the forecasted bookings. If the number of bookings (or some other measure of demand) from the actual and the forecast are within a specified threshold, the experiment may be considered a success. Otherwise, the elasticity tester may record an unsuccessful result for the experiment and revert to the original rate going forward.

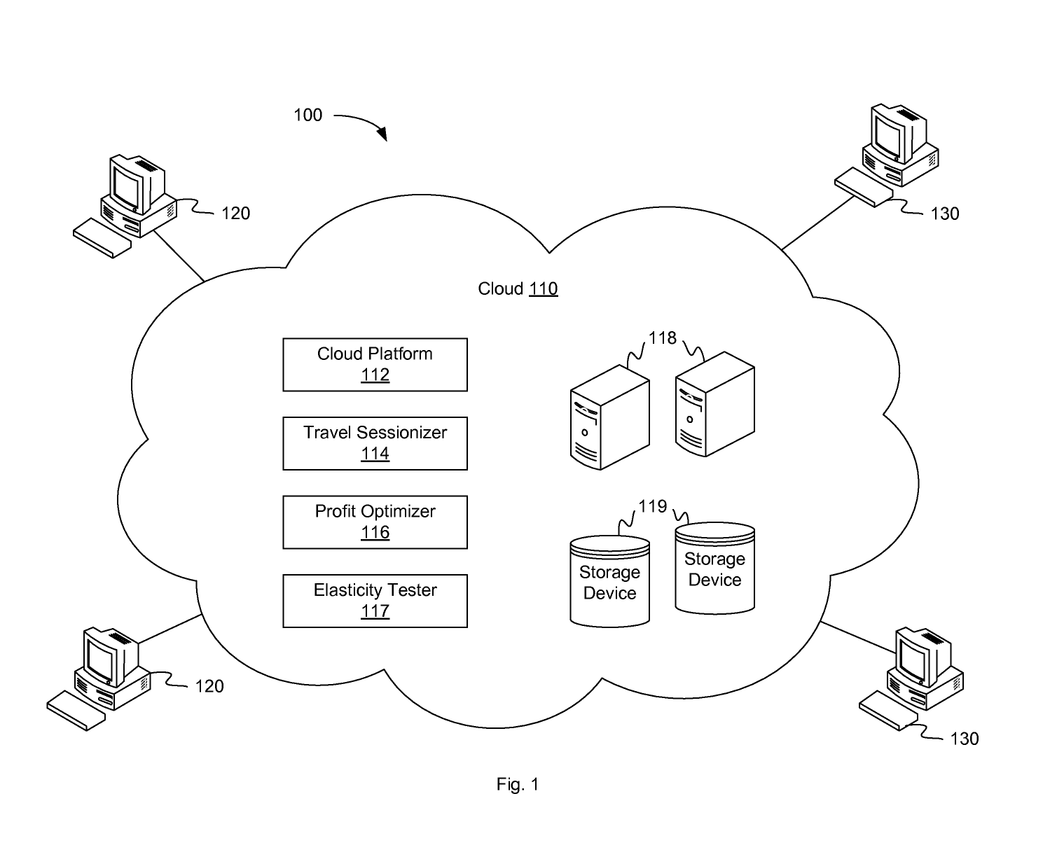

FIG. 1 is a block diagram illustrating a cloud computing environment for a multi-tenant cloud architecture, according to an embodiment of the present invention. In one embodiment, cloud computing environment 100 includes cloud 110, one or more user devices 120, and one or more property devices 130. User devices 120 and property devices 130 may be used to access the resources of the cloud 110, and may include, for example, personal computers (PCs), workstations, laptop computers, tablet computers, mobile phones, personal digital assistants (PDAs) or the like. In one embodiment, user devices 120 may be personal computing devices used by individuals to shop for or browse travel properties (e.g., hotels, motels, bed and breakfasts, condominiums, houses). Property devices 130 may be computing devices used by property managers, owners, or employees to access demand forecasting, profit maximization, elasticity testing or other resources available in cloud 110. Cloud 110 may include a group of networked computing resources accessible to the user devices 120 and property devices 130 over a network, such as a local area network (LAN), a wide area network (WAN), a global area network (GAN) such as the Internet, or a combination of such networks. The resources available in the cloud 110 may include, for example, processing devices, storage devices, applications, or other resources. The cloud 110 allows for a functional separation between the computing resources used, the user devices 120 where a user is working, and the property devices 130 where a property manager or owner is working. The cloud 110 may provide access to a vast network of computing resources and allow individuals to use data or resource intensive applications driven by cloud technology which may or may not be available locally given the limitations of the user devices 120 or the property devices 130.

In one embodiment cloud 110 includes cloud platform 112, travel sessionizer 114, profit optimizer 116, elasticity tester 117, one or more application servers (or application server instances) 118, and one or more storage devices 119. Each of these resources may be located at the same location or at different locations, and may be connected to one another and/or to user devices 120 and property devices 130 through the network, as discussed above. Storage devices 119 may be, for example, memory, such as read-only memory (ROM), flash memory, random access memory (RAM), etc., or mass storage devices, such as a magnetic or optical storage devices, or a combination thereof. In one embodiment, user devices 120 and property devices 130 may interact directly with could platform 112. Cloud platform 112 may include software configured to provide access to the other resources in the cloud 110. Cloud platform 112 may cause the cloud resources, such as application servers 118 or storage devices 119, to appear, for example, as web pages or as virtual machines on user devices 120 or property devices 130.

Cloud platform 112 may pass messages between user devices 120 and property devices 130, and travel sessionizer 114, profit optimizer 116 and elasticity tester 117. In one embodiment, travel sessionizer 114 captures raw event data from the travel shopping actions of users on user devices 120 and parses the raw event data into separate travel sessions. In one embodiment, a travel session includes the shopping, browsing, searching etc., done by one individual (or on one of user devices 120) for travel on a set of similar dates. For example, a travel session may include the searches performed by a user for travel over a certain weekend, or travel within several days of that weekend. The data associated with the search, including, for example, a destination city, specific properties, dates of arrival, length of stay, room type, property amenities, price quotes, availability information, and/or other travel information, may be included in a specific travel session associated with the user. Thus, the data in a given travel session is associated with a single trip. Travel sessionizer 114 may store this travel session data on one of storage devices 119 in cloud 110. If travel sessionizer 114 determines that the user makes additional searches for the same trip, travel sessionizer 114 may add any additional data to the same travel session.

In addition, travel sessionizer 114 may aggregate data from other sources as well. For example, travel sessionizer 114 may receive data, such as pricing information, customer feedback, etc. from a property website which may be hosted on one of application servers 118 or from a third party website which offer bookings at the travel property. Travel sessionizer may also receive property information from competitor property websites. Travel sessionizer 114 may receive data, such as bookings, rate codes (e.g., a unique identifier associated with the rate charged for a particular booking), etc. from a booking engine or a customer relationship management (CRM) system which may be hosted on one of application servers 118. In other embodiments, travel sessionizer 114 may receive data from other sources not explicitly referenced herein. In addition, in other embodiments, the data received from these other sources may include data other than travel data. For example, the principles and techniques described herein may be applied to data in other domains to issue alerts when that data varies from the expected norm. The benefits experienced in these other domains, as a result, may be similar to those described herein for travel data.

In one embodiment, profit optimizer 116 uses the travel session data identified by travel sessionizer 114 to forecast the demand at a given property on a certain date and determine a price for rooms at the property on that date that will increase or optimize the profit. Property managers, owners or employees using property devices 130 can access the findings of profit optimizer 116 and choose to implement the suggested prices in the sale of rooms at the property.

In one embodiment, elasticity tester 117 can perform experiments to test the elasticity of price or other factors with respect to the demand for a given property. Other factors that could be tested may include, for example, room type differentials or bundled offers. The price is considered to be inelastic when it can be varied without significant impact on the demand. If the price is inelastic, then property managers, owners or employees could potentially make adjustments to the price (e.g., increase the price) without impacting demand, thereby increasing their profits. In another embodiment, elasticity tester 117 may decrease the price in hopes of increasing the demand and thus, the overall revenue. In one embodiment, elasticity tester 117 can determine the forecasted demand at a given price for a period of time at the property from profit optimizer 116. Elasticity tester 117 can then adjust the price according to test configuration parameters. The test configuration parameters may include a target date, a price variance amount, experiment start and stop dates, a specific segment to test, a variance threshold for termination of the experiment, etc. During the experiment, elasticity tester 117 can monitor the actual demand with the adjusted price and compare the actual demand to the forecasted demand. The results of the comparison can be used to impact future demand forecasts, profit optimizing price recommendations, etc. Additional details regarding elasticity tester 117 will be provided below.

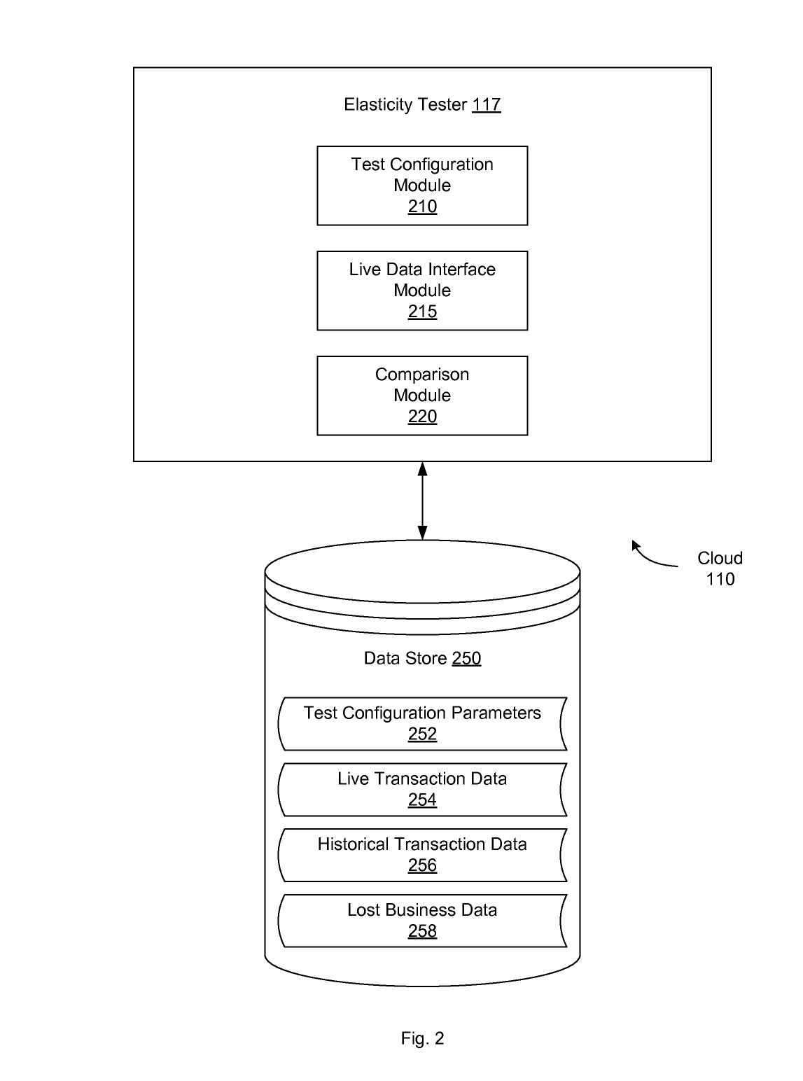

FIG. 2 is a block diagram illustrating an elasticity tester, according to an embodiment. In one embodiment, elasticity tester 117 may be implemented by one of application servers 118 in cloud 110, as shown in FIG. 1. In one embodiment, elasticity tester 117 includes test configuration module 210, live data interface module 215, and comparison module 220. This arrangement of modules and components may be a logical separation, and in other embodiments, these modules or other components can be combined together or separated in further components, according to a particular embodiment. In one embodiment, data store 250 is connected to elasticity tester 117 and stores test configuration parameters 252, live transaction data 254, historical transaction data 256 and lost business data 258. In one embodiment, cloud 110 may include elasticity tester 117 and data store 250. In another embodiment, data store 250 may be external to cloud 110 and may be connected over a network or other connection. In other embodiments, elasticity tester 117 may include different and/or additional components which are not shown to simplify the description. Data store 250 may include a file system, database or other data management layer resident on one or more mass storage devices which can include, for example, flash memory, magnetic or optical disks, or tape drives; read-only memory (ROM); random-access memory (RAM); erasable programmable memory (e.g., EPROM and EEPROM); flash memory; or any other type of storage medium.

In one embodiment, test configuration module 210 handles the setup and execution of pricing elasticity experiments. In one embodiment, pricing elasticity experiments are controlled by test configuration parameters 252 in data store 250. For example, the test configuration parameters 252 may include the travel property, the segment of the booking, the day of arrival for the experiment, the start and end dates of the experiment, the price adjustment or other factors. In one embodiment, the price adjustment may be relatively small (e.g., on the order of a 5-10% increase or decrease from the recommended price). In other embodiments, however, the price adjustment may be any amount, including larger or smaller amounts. In some embodiments, the price adjustment may be very small (e.g., on the order of a 1% or less than 1% increase or decrease). In one embodiment, for ease of explanation, a day for which the travel property is booked may be referred to as the “day of arrival” or the “arrival day,” although it should be understood that a guest need not necessarily arrive at the property on that day, but rather just make a reservation for that day/night. For example, the guest may have checked-in to the property on an earlier day, but their stay includes the “day of arrival.” In one embodiment, the segment may include a group of customers that exhibit a similar booking behavior. Examples of segments may include customers that are part of a group staying at the property (e.g., for a wedding or a conference) and customers that book through a certain channel (e.g., property website, travel website, telephone, in-person). The start date and end date of the experiment generally fall some period of time prior to the date of arrival and are used to define the period of time for which the price will be adjusted (i.e., the experiment period). The experiment period generally covers the time during which a customer would make a reservation or booking in order to stay at the travel property on the day of arrival. In one embodiment, the start and end dates of the experiment are configurable by the user. The dates may be set to any period of time prior to the day of arrival and may have any period of time between them. In another embodiment, the start and end of the experiment are expressed as time values on either the same or different days. For example, the experiment could run for a period of several hours within a single day. In one embodiment, the start and end dates of the experiment period are selected in order to achieve the most meaningful results. For example, test configuration module 210 could use historical transaction data 256 to determine periods of time prior to a given day of arrival that experience certain trends. These trends could include periods of customer elasticity, periods of customer inelasticity, periods of high booking volume, periods of low booking volume or other trends. The user could select to perform the experiment during a period with one of these expected trends in order to see how the results would be effected by a price adjustment.

In one embodiment, live data interface module 215 monitors live transaction data 254 which represents bookings at the travel property as they are made. For example, each time a new booking is made at the travel property a record of that booking may be made in live transaction data 254. During the experiment period initiated by test configuration module 210, live data interface module 215 may record bookings for the day of arrival at the travel property with the adjusted price as they occur.

In one embodiment, comparison module 220 compares the actual bookings during the experiment period from live transaction data 254 to an expected number of bookings during the experiment period as determined by profit optimizer 116. For example, comparison module 220 may determine a difference between the actual number of bookings and the expected number of bookings. In one embodiment, comparison module 220 may compare this difference to a defined threshold. In one embodiment, the threshold may be 50% of the expected number of bookings. The threshold, however, may be completely configurable and may be set to any other value in other embodiments. If the different meets or exceeds the defined threshold, comparison module 220 may notify test configuration module 210, which may terminate the experiment. In other embodiments, comparison module 220 may not rely on any predefined thresholds at all, but may instead use an alternative decision-making process for determining experiment termination.

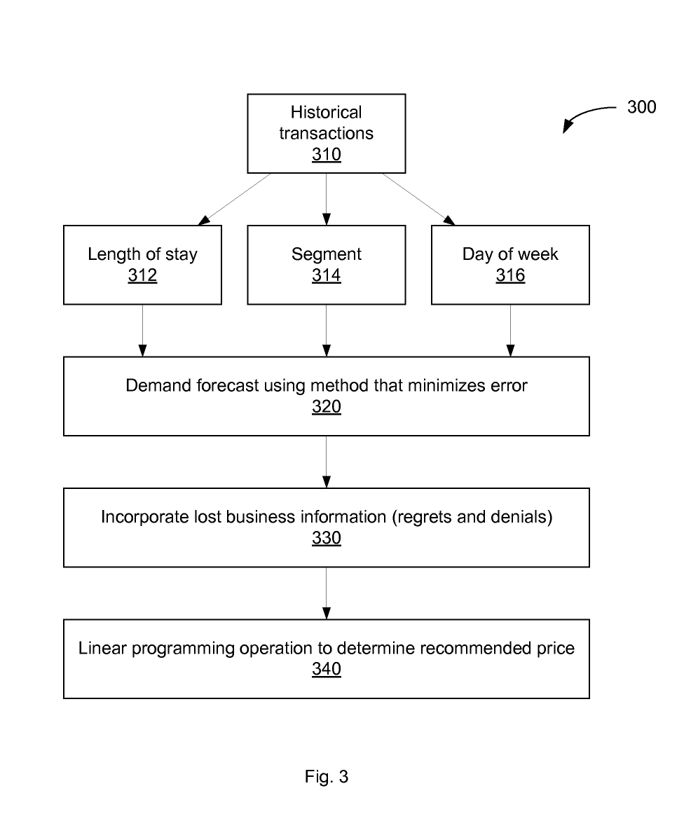

FIG. 3 is a block diagram illustrating a demand forecasting and price determining processing flow, according to an embodiment of the present invention. The various modules and components may be described in regards to their roles in forecasting the demand for a property on a given day in the future. In one embodiment, the operations in processing flow 300 may be performed by profit optimizer 116, as shown in FIG. 1.

In one embodiment, the processing flow 300 begins with dividing historical transaction data 310 into a number of usable buckets. The historical transactions 310 may include information about bookings made at the property in the past. In one embodiment, historical transaction data 310 may be obtained from a booking engine or central reservation system associated with the property. In one embodiment, historical transaction data 310 is one representation of historical transaction data 256 in data store 250. The buckets into which historical transaction data 310 is divided may be groups of data that share similar characteristics. For example, one bucket may include the length of stay 312 for a booking at the property. In one embodiment, each transaction where a user books one or more consecutive nights at a property may be grouped together with other transactions booked for the same period of time (e.g., 1 night, 2 nights, 3 nights, etc.). In another embodiment, if the number of transactions in any one bucket is too low (e.g., below a defined threshold), one or more buckets may be combined. For example, if it is recognized that certain characteristics of transactions having a length of stay of 3 nights and 4 nights are similar, all of those transactions may be grouped together into a single bucket, for certain processing operations. Another bucket may include the segment 314 to which a customer belongs. Segments 314 may include groups of customers that exhibit a similar booking behavior. Examples of segments 314 may include customers that are part of a group staying at the property (e.g., for a wedding or a conference) and customers that book through a certain channel (e.g., property website, travel website, telephone, in-person). The segments 314 that make up one of the buckets may be set to default values or may be configurable by the user of the system. Another bucket may include the day of the week 316 on which the day of arrival falls. In one embodiment, trends may develop over time for the same day of the week. Thus, historical transactions 310 may include, for example, the number of bookings made for the same day of the week 316 as the day of arrival during some number of previous weeks. In another embodiment, if the number of transactions in any one bucket is too low (e.g., below a defined threshold), one or more buckets may be combined. For example, if it is recognized that certain characteristics of transactions on Tuesdays and Wednesdays are similar, all of those transactions may be grouped together into a single bucket, for certain processing operations. In another embodiment, historical transactions 310 may include the number of bookings made between the current day (i.e., the “day of forecast”) and the day of arrival. The bookings made during this period of time (e.g., 5 days) during some number of previous weeks may be relevant. In other embodiments, historical transactions 310 may be divided into one or more of these buckets or other buckets not specifically described herein.

The data from each of buckets 312, 314 and 316 may be used to determine a demand forecast 320 using a method that minimizes a forecasting error. Examples of demand forecasting methods may include regression, a moving average, exponential smoothing, Bayesian, or some other forecasting method. Regression analysis may include a technique for forecasting demand based on the relationship of a number of independent variables including, for example, date, day of the week, location of the property, price of the room, or others. A moving average may include the average of a fixed sample (e.g., the bookings from a number of previous weeks) that is continuously shifted forward in time (i.e., to include only the most recent data). Exponential smoothing may include an average of the number of bookings from the past weeks that are weighted with exponentially decreasing values over time, so that the more recent data is weighted more heavily in forecasting the demand. A Bayesian average may be used to forecast the demand, but instead of estimating the average strictly from the previous booking information, other existing information related to that data may also be incorporated into the calculation in order to minimize the impact of large deviations. In one embodiment, the demand forecast 320 may be dynamically calculated using one or more of these or other forecasting methods and the forecast that is actually used may be the one that minimizes forecasting error. The forecasting error may be measured, for example, based on a median absolute deviation, a mean absolute percentage error, or by some other method.

Depending on the embodiment, the demand forecast 320 may be expressed in any of a number of different ways. For example, the demand forecast may be expressed as the total number of bookings expected to have been received for the day of arrival on a given day, the number of new bookings expected to be received for the day of arrival on a given day (also referred to as the “pickup”), the total number of bookings expected to be received on any day for the day of arrival, or some other measure of demand for the travel property. As used herein, the “demand” for a travel property and the “number of bookings” for a travel property may be used interchangeably with the understanding that any of the above or other meanings may apply.

Upon forecasting the demand 320, lost business information 330 may be incorporated into the forecast. In one embodiment, the lost business information includes regrets and denials that did not result in an actual booking for the property. Regrets are generated when a potential customer searches for or inquires about a room at the property but does not ultimately book the room. Denials are generated when a potential customer is unable to book a room because either the property or the specific room type that they are searching for is sold out or otherwise unavailable on the day of arrival. This lost business information 330 can be informative of the interest in the property on the day in question and may affect the demand forecast 320. In one embodiment, lost business information 330 is one representation of lost business data 258 in data store 250.

The result of the demand forecast 320, as affected by lost business information 330, can be used to determine a recommended price 340. In one embodiment, the recommended price represents the highest price that a property can charge for an extra room at the property (and have the room be booked) based on the forecasted demand 320. In one embodiment, the recommended price is determined based on prices charged in historical transactions 310 and adjusted based on the forecasted demand.

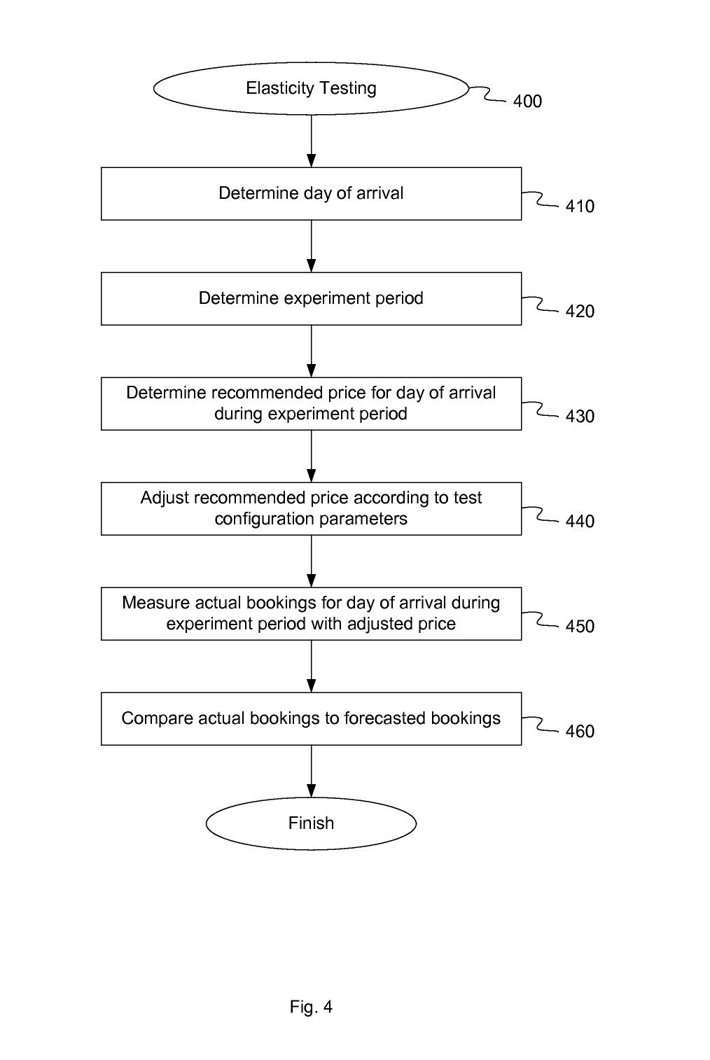

FIG. 4 is a flow diagram illustrating an elasticity testing method, according to an embodiment. The method 400 may be performed by processing logic that comprises hardware (e.g., circuitry, dedicated logic, programmable logic, microcode, etc.), software (e.g., instructions run on a processor to perform hardware simulation), or a combination thereof. The processing logic is configured to setup and execute an experiment to test the elasticity of pricing at a given property by varying the price for period of time to see the impact of that variance on the demand at the property. In one embodiment, method 400 may be performed by elasticity tester 117, as shown in FIGS. 1 and 2.

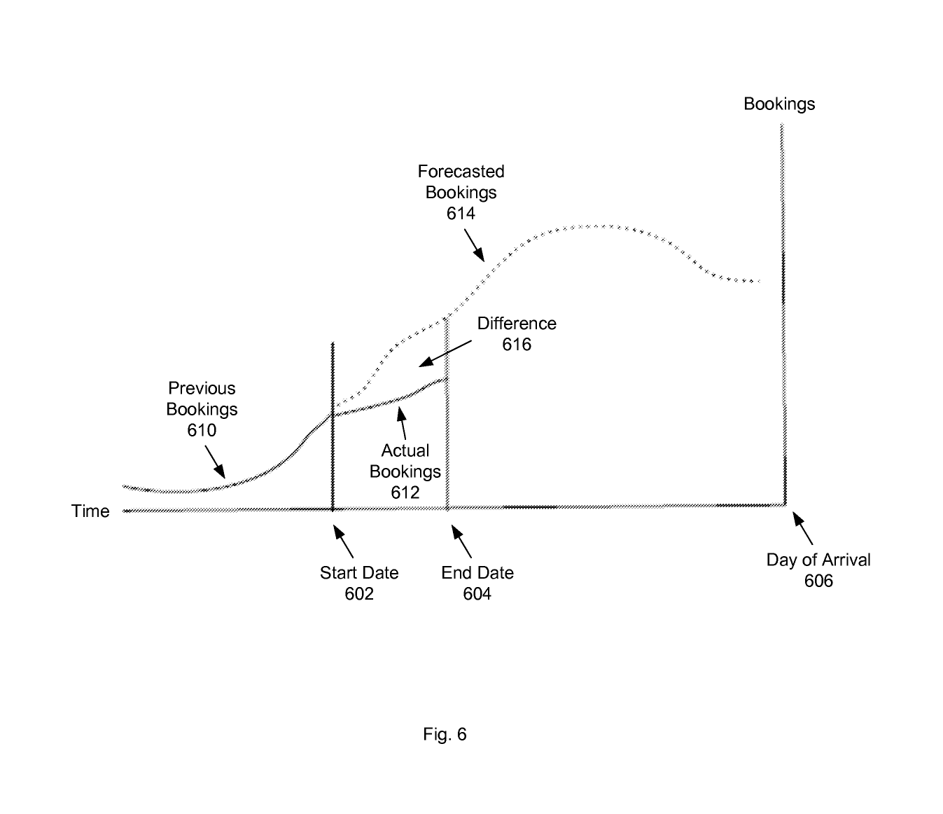

Referring to FIG. 4, at block 410, method 400 determines the day of arrival. In one embodiment, test configuration module 210 determines the day of arrival from the test configuration parameters 252. The day of arrival may also be referred to as the “target date” and may indicate they day for which the booking is made (i.e., the day which the guest will stay at the travel property). In one embodiment, the day of arrival, along with the rest of the test configuration parameters 252, is set by an owner, property manager, employee or other user of elasticity tester 117. In this manner, the user may customize the experiment in order to test price elasticity under a specific set of conditions. FIG. 6 is diagram illustrating a booking curve for a price elasticity experiment, according to an embodiment. In FIG. 6, the day of arrival 606 is shown at the far right, with time progressing from left to right.

Referring again to FIG. 4, at block 420, method 400 determines the experiment period. In one embodiment, test configuration module 210 determines the experiment start date and the experiment end date from the test configuration parameters 252. The period of time between the experiment start date and the experiment end date represents the experiment period. The experiment period generally covers the time during which a customer would make a reservation or booking in order to stay at the travel property on the day of arrival. In FIG. 6, the experiment period is shown by the start date 602 and the end date 604 of the experiment. In one embodiment, the start date 602 may be seven days prior to the day of arrival 606 and the end date 604 may be five days prior to the day of arrival 606, making the length of the experiment period two days. In other embodiments, the experiment period may be some other time prior to the day of arrival 606 or may have some other length.

At block 430, method 400 determines a recommended price for the day of arrival during the experiment period. In one embodiment, profit optimization module 116 calculates a recommended price (or optimized price). In one embodiment, the recommended price represents the highest price that a property can charge for an extra room at the property (and have the room be booked) based on the forecasted demand. For example, if the offer price for a room at the property is above the recommended price, it is unlikely that a booking will result, because the demand forecast cannot support that price. If the offer price is below the recommended price, the room will likely be booked, but the property could likely have gotten a higher price for the room. If the offer price is equal to the recommended price, the property can likely optimize its profit, by obtaining a booking at the highest possible price for the extra room. In one embodiment, the recommended price is determined based on prices charged in historical transactions and adjusted based on the forecasted demand. For example, if the forecasted demand is higher than the actual demand was at a certain time in the past, the recommended price may be increased from what the actual offer price was at that time in the past. In another embodiment, the recommended price may be a standard price, default price or some other price, calculated based on various factors, such as competitor rate information.

At block 440, method 400 adjusts the recommended price according to test configuration parameters. In one embodiment, test configuration module 210 adjusts the recommended price determined at block 430 by a certain amount defined in test configuration parameters 252. For example, test configuration module 210 may increase (or decrease) the quoted price for a stay at the travel property on the day of arrival during the experiment period. As a result, customers who request a price quote during the experiment period for travel to the property on the day of arrival will be provided with the adjusted price, rather than the recommended price they would have received if an elasticity experiment were not being performed. In general, however, the customer is unaware of the occurrence of the elasticity experiment. In one embodiment, the recommended price is recalculated periodically. For example, the recommended price may be recalculated during the experiment period. In this case, the user may optionally allow the adjusted price (i.e., the recommended price plus some defined increase amount) to change as well. Similarly, the forecasted demand may also be updated to reflect the recalculated price.

At block 450, method 400 measures actual bookings for the day of arrival during the experiment period with the adjusted price. In one embodiment, live data interface module 215 monitors live transaction data 254 which represents bookings at the travel property as they are made. During the experiment period, live data interface module 215 may record bookings for the day of arrival at the travel property, or some other measure of demand, with the adjusted price. In FIG. 6, the previous bookings 610 for the day of arrival are known. The actual bookings 614 are new bookings for the day of arrival 606 that are received between the start date 602 and the end date 604 of the experiment. In another embodiment, rather than using actual bookings, the experiment may be based on web capture conversion rates. Web capture conversion rates may be a measure of what portion of shoppers (i.e., potential customers) actually made a booking. In one embodiment, the conversion rate may be expressed as the (actual bookings 614/(regrets from lost business data 258+actual bookings 614)). The actual measured conversion rates may later be compared to forecasted conversion rates to determine the success of the experiment. In other embodiments, the experiment may be conducted using some other metric for the travel property.

At block 460, method 400 compares the actual bookings with the adjusted price to the forecasted bookings with the recommended price. In one embodiment, comparison module 220 compares the actual bookings during the experiment period from block 450 to an expected number of bookings during the experiment period as determined by profit optimizer 116. For example, comparison module 220 may determine a difference between the actual number of bookings when the price is adjusted (e.g., increased) and the expected number of bookings at the default or recommended price. In FIG. 6, the forecasted bookings 614 are determined by profit optimizer 116. Comparison module 220 may compare the actual bookings 614 are to the forecasted bookings 614 during the experiment period in order to determine the difference 616 between them. This difference 616 may be informative of whether or not the property manager or user could increase their prices without suffering a loss in bookings. In addition, the difference may be useful in improving the demand forecast for the travel property in the future. For example, there may be a relationship between the offer price for a room and the number of bookings received at the travel property. In one embodiment, the relationship may be summarized as the number of bookings increases as the offer price decreases. The measurement data from the experiment generally includes how much the number of bookings increases or decreases with respect to a give price adjustment. This information can be used by profit optimizer 116 when calculating the demand forecast for a given day in the future. Among other factors, the demand forecast may take into account the offer price for a room on a given day. The measurement data obtained from the experiment can affect the expected number of bookings based on a given offer price, which in turn affects the demand. As a result, the system can achieve a more accurate demand forecast.

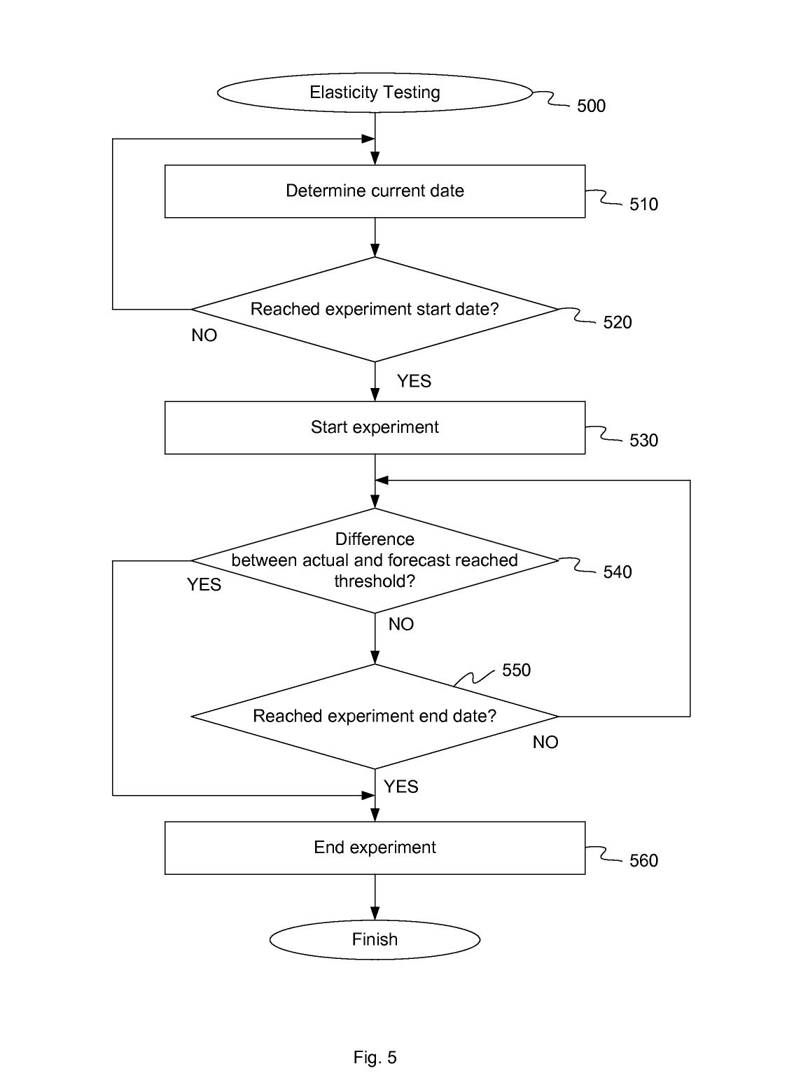

FIG. 5 is a flow diagram illustrating an elasticity testing method, according to an embodiment. The method 400 may be performed by processing logic that comprises hardware (e.g., circuitry, dedicated logic, programmable logic, microcode, etc.), software (e.g., instructions run on a processor to perform hardware simulation), or a combination thereof. The processing logic is configured to run an experiment to test pricing elasticity by varying the price for a given period of time or until the actual results deviate from the expected results by a threshold amount. In one embodiment, method 500 may be performed by elasticity tester 117, as shown in FIGS. 1 and 2.

Referring to FIG. 5, at block 510, method 500 determines the current date. In one embodiment, test configuration module 210 accesses a calendar, clock or other timekeeping program to determine the current date. In another embodiment, test configuration module 210 keeps track of the current date internally and thus, has no need to access an external program. In yet another embodiment, test configuration module 210 receives the current date (or some other date) as input from a user of elasticity tester 117.

At block 520, method 500 determines if the experiment start date has been reached. In one embodiment, test configuration module 210 accesses test configuration parameters 252 which define the experiment start date 602. Test configuration module 210 compares the current date determined at block 510 to the experiment start date 602 to determine if the current date matches or has past the experiment start date 602.

If the experiment start date has been reached, at block 530, method 500 starts the experiment. In one embodiment, test configuration module 210 initiates the experiment by adjusting the quoted price for the travel property on the day of arrival by a certain amount defined in test configuration parameters 252. For example, test configuration module 210 may increase (or decrease) the quoted price for a stay at the travel property on the day of arrival 606. As a result, customers who request a price quote during the experiment period for travel to the property on the day of arrival 606 will be provided with the adjusted price.

At block 540, method 500 determines whether the difference between the actual demand and the forecasted demand has reached a predetermined threshold. In one embodiment, comparison module 220 compares the actual bookings 612 (or other measure of demand) during the experiment period (from live transaction data 254 as determined by live data interface module 215) to an expected number of bookings 614 during the experiment period as determined by profit optimizer 116. For example, comparison module 220 may determine a difference between the actual number of bookings 612 when the price is adjusted (e.g., increased) and the expected number of bookings 614 at the default or recommended price. Comparison module 220 may further compare this difference to defined threshold. The threshold may represent a difference value that should not be exceeded. The rationale being that if the actual bookings fall below the expected bookings by a certain amount, either some unexpected event occurred and the experiment is invalid or the price for the day of arrival at the travel property is inelastic and the travel property should maintain the recommended price in order to prevent losing revenue.

If the difference has reached the predetermined threshold, method 500 proceeds to block 560 and ends the experiment. In one embodiment, test configuration module 210 ends the experiment by returning the quoted price for the travel property on the day of arrival back to the recommended, default or previous price. In another embodiment, rather than ending the experiment automatically, test configuration module 210 provides a notification to the owner, property manager or other user to inform them of the discrepancy. In this case, the decision of whether to terminate the experiment or allow it to continue may be left up to the user.

If the difference has not reached the predetermined threshold, at block 550, method 500 determines whether the experiment end date has been reached. In one embodiment, test configuration module 210 accesses test configuration parameters 252 which define the experiment end date 604. Test configuration module 210 compares the current date determined at block 510 to the experiment end date 604 to determine if the current date matches or has past the experiment end date 604. If the experiment end date has been reached, at block 560, method 500 ends the experiment.

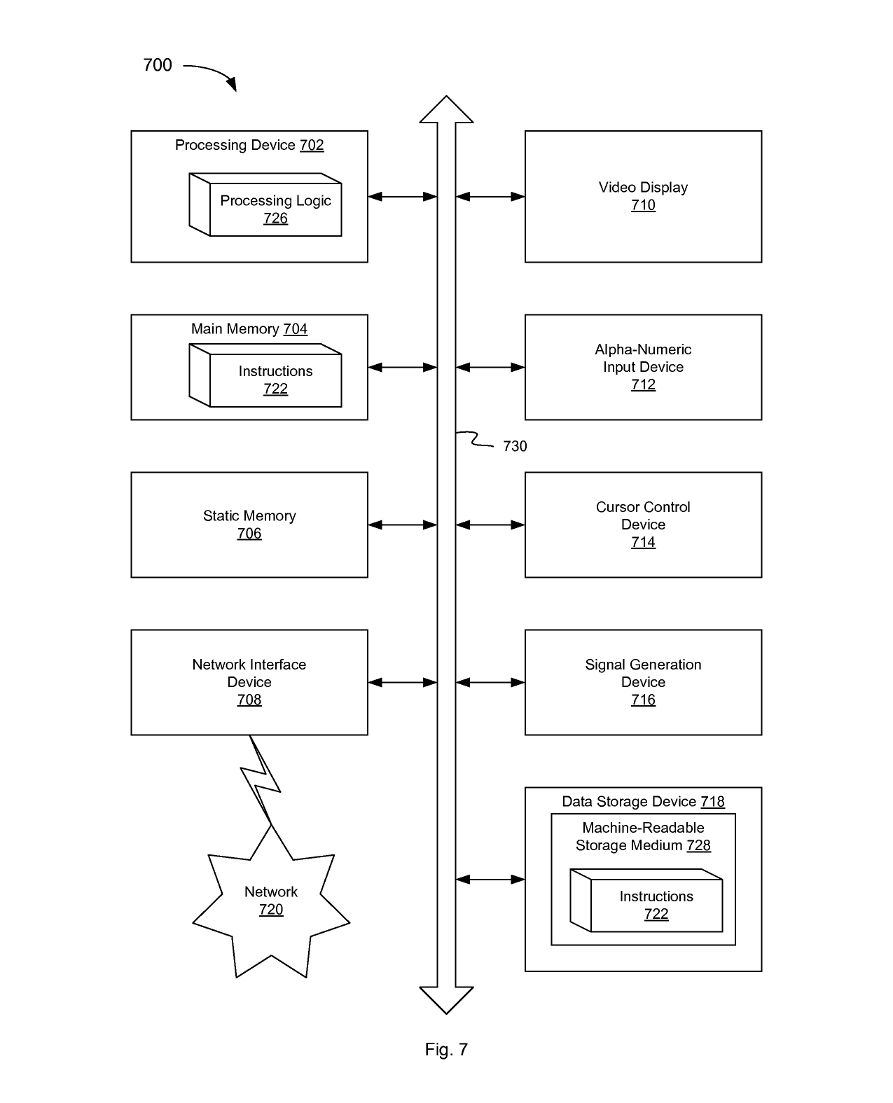

FIG. 7 illustrates a diagrammatic representation of a machine in the exemplary form of a computer system 700 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. In one embodiment, computer system 700 may be representative of a computing device, such as user device 120, property device 130 or a computer used to support cloud 110 and run elasticity tester 117.

The exemplary computer system 700 includes a processing device 702, a main memory 704 (e.g., read-only memory (ROM), flash memory, dynamic random access memory (DRAM) (such as synchronous DRAM (SDRAM) or Rambus DRAM (RDRAM), etc.), a static memory 706 (e.g., flash memory, static random access memory (SRAM), etc.), and a data storage device 718, which communicate with each other via a bus 730. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines and each of the single signal lines may alternatively be buses.

Processing device 702 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 702 may also be one or more special-purpose processing devices such as an application specific integrated circuit (ASIC), a field programmable gate array (FPGA), a digital signal processor (DSP), network processor, or the like. The processing device 702 is configured to execute processing logic 726 for performing the operations and steps discussed herein.

The computer system 700 may further include a network interface device 708. The computer system 700 also may include a video display unit 710 (e.g., a liquid crystal display (LCD) or a cathode ray tube (CRT)), an alphanumeric input device 712 (e.g., a keyboard), a cursor control device 714 (e.g., a mouse), and a signal generation device 716 (e.g., a speaker).

The data storage device 718 may include a machine-accessible storage medium 728, on which is stored one or more set of instructions 722 (e.g., software) embodying any one or more of the methodologies of functions described herein. The instructions 722 may also reside, completely or at least partially, within the main memory 704 and/or within the processing device 702 during execution thereof by the computer system 700; the main memory 704 and the processing device 702 also constituting machine-accessible storage media. The instructions 722 may further be transmitted or received over a network 720 via the network interface device 708.

The machine-readable storage medium 728 may also be used to store instructions system triggered travel alerts, as described herein. While the machine-readable storage medium 728 is shown in an exemplary embodiment to be a single medium, the term “machine-readable storage medium” should be taken to include a single medium or multiple media (e.g., a centralized or distributed database, and/or associated caches and servers) that store the one or more sets of instructions. A machine-readable medium includes any mechanism for storing information in a form (e.g., software, processing application) readable by a machine (e.g., a computer). The machine-readable medium may include, but is not limited to, magnetic storage medium (e.g., floppy diskette); optical storage medium (e.g., CD-ROM); magneto-optical storage medium; read-only memory (ROM); random-access memory (RAM); erasable programmable memory (e.g., EPROM and EEPROM); flash memory; or another type of medium suitable for storing electronic instructions.

Although the operations of the methods herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

1. A method comprising:
initiating a price elasticity experiment during an experiment period, the price elasticity experiment to test a price elasticity for bookings made during the experiment period for a travel property for a day of arrival;
adjusting a recommended price to an adjusted price for the travel property during the experiment period according to user-defined test configuration parameters;
measuring actual bookings made during the experiment period for the travel property for the day of arrival at the adjusted price; and
comparing, by a processing device, the actual bookings made at the adjusted price to forecasted bookings for the travel property at the recommended price.

2. The method of claim 1, wherein the experiment period is defined by a start date and an end date, the test configuration parameters comprising the start date and the end date.

3. The method of claim 1, wherein the recommended price is based on a capacity of the travel property and a forecasted demand for bookings at the travel property, and wherein the recommended price is designed to increase a profit for the travel property.

4. The method of claim 1, wherein adjusting the recommended price to the adjusted price comprises increasing the recommended price by a determined amount as specified in the test-configuration parameters during the experiment period.

5. The method of claim 1, wherein comparing the actual bookings to the forecasted bookings comprises at least one of determining a difference between the actual bookings and the forecasted bookings during the experiment period or determining a difference between an actual conversion rate and a forecasted conversion rate during the experiment period.

6. The method of claim 5, further comprising:
comparing the difference between the actual bookings and the forecasted bookings during the experiment period to a threshold defined in the test configuration parameters; and
if the difference between the actual bookings and the forecasted bookings during the experiment period meets the threshold, terminating the experiment by reverting back to the recommended price.

7. The method of claim 2, further comprising:
determining whether the experiment end date has been reached; and
if the experiment end date has been reached, terminating the experiment by reverting back to the recommended price.

8. A system comprising:
a processing device;
a memory operatively coupled to the processing device, the memory to store an elasticity tester, executable by the processing device from the memory, the elasticity tester to:
initiate a price elasticity experiment during an experiment period, the price elasticity experiment to test a price elasticity for bookings made during the experiment period for a travel property for a day of arrival;
adjust a recommended price to an adjusted price for the travel property during the experiment period according to user-defined test configuration parameters;
measure actual bookings made during the experiment period for the travel property for the day of arrival at the adjusted price; and
compare the actual bookings made at the adjusted price to forecasted bookings for the travel property at the recommended price.

9. The system of claim 8, wherein the experiment period is defined by a start date and an end date, the test configuration parameters comprising the start date and the end date.

10. The system of claim 8, wherein the recommended price is based on a capacity of the travel property and a forecasted demand for bookings at the travel property, and wherein the recommended price is designed to increase a profit for the travel property.

11. The system of claim 8, wherein to adjust the recommended price to the adjusted price, the elasticity tester to increase the recommended price by a determined amount as specified in the test-configuration parameters during the experiment period.

12. The system of claim 8, wherein to compare the actual bookings to the forecasted bookings, the elasticity tester to determine at least one of a difference between the actual bookings and the forecasted bookings during the experiment period or a difference between an actual conversion rate and a forecasted conversion rate during the experiment period.

13. The system of claim 12, wherein the elasticity tester further to:
compare the difference between the actual bookings and the forecasted bookings during the experiment period to a threshold defined in the test configuration parameters; and
if the difference between the actual bookings and the forecasted bookings during the experiment period meets the threshold, terminate the experiment by reverting back to the recommended price.

14. The system of claim 9, wherein the elasticity tester further to:
determine whether the experiment end date has been reached; and
if the experiment end date has been reached, terminate the experiment by reverting back to the recommended price.

15. A non-transitory computer-readable storage medium storing instructions which, when executed, cause a processing device to perform operations comprising:
initiating a price elasticity experiment during an experiment period, the price elasticity experiment to test a price elasticity for bookings made during the experiment period for a travel property for a day of arrival;
adjusting a recommended price to an adjusted price for the travel property during the experiment period according to user-defined test configuration parameters;
measuring actual bookings made during the experiment period for the travel property for the day of arrival at the adjusted price; and
comparing, by the processing device, the actual bookings made at the adjusted price to forecasted bookings for the travel property at the recommended price.

16. The non-transitory computer-readable storage medium of claim 15, wherein the experiment period is defined by a start date and an end date, the test configuration parameters comprising the start date and the end date.

17. The non-transitory computer-readable storage medium of claim 15, wherein the recommended price is based on a capacity of the travel property and a forecasted demand for bookings at the travel property, wherein the recommended price is designed to increase a profit for the travel property; and wherein adjusting the recommended price to the adjusted price comprises increasing the recommended price by a determined amount as specified in the test-configuration parameters during the experiment period.

18. The non-transitory computer-readable storage medium of claim 15, wherein comparing the actual bookings to the forecasted bookings comprises at least one of determining a difference between the actual bookings and the forecasted bookings during the experiment period or determining a difference between an actual conversion rate and a forecasted conversion rate during the experiment period.

19. The non-transitory computer-readable storage medium of claim 18, the operations further comprising:
comparing the difference between the actual bookings and the forecasted bookings during the experiment period to a threshold defined in the test configuration parameters; and
if the difference between the actual bookings and the forecasted bookings during the experiment period meets the threshold, terminating the experiment by reverting back to the recommended price.

20. The non-transitory computer-readable storage medium of claim 16, the operations further comprising:
determining whether the experiment end date has been reached; and
if the experiment end date has been reached, terminating the experiment by reverting back to the recommended price.
